(19) United States
(12) Patent Application Publication
(10) Pub. No.: US 2002/0121025 A1
(43) Pub. Date: Sep. 5, 2002

(54) Modular level

(76) Inventor: Shawn S. Leite, Middleboro, MA (US)

Correspondence Address: Richard C. Litman, LITMAN LAW OFFICES, LTD., P.O. Box 15035, Arlington, VA, 22215, US

(21) Appl. No.: 09/922,075

(22) Filed: Aug. 6, 2001

Related U.S. Application Data
(60) Provisional application No. 60/272,310, filed on Mar. 2, 2001.

(51) Int. Cl. G01C 9/00

(52) U.S. Cl. 33/374

(57) ABSTRACT

A modular level is formed of unequal length first and second components which may be joined to form a single, elongate level or alternatively joined to form a framing square. Each component includes a series of level vials, enabling each component or joined components to be used for determining horizontal and/or vertical lines. The first component has a pair of pins extending from one end, parallel to its elongate axis. The second component has a first pair of passages in a first end parallel to its elongate axis, for joining the two components end to end to form a single long level. The second component also has a second pair of passages in its second end orthogonal to the first passages, for joining the two components at right angles to form a framing square. A storage compartment may also be provided in one component.

### CROSS-REFERENCE TO RELATED APPLICATION

This application claims the benefit of U.S. Provisional Patent Application Serial No. 60/272,310, filed Mar. 2, 2001.

### BACKGROUND OF THE INVENTION

1. Field of the Invention

The present invention relates generally to measuring devices, and more particularly to a modular level having two components which may be assembled to form a straightedge and level having a length longer than either of the separate components, or to form a right angle square having level means in both legs of the square.

2. Description of Related Art

The conventional spirit or “bubble” level has been used for generations for laying out reasonably precise level lines, and for defining vertical edges and non-vertical slopes and lines, where adjustment of the level vial(s) is provided in the tool. Most such tools are on the order of one to two feet long, but it will be seen that longer lengths can provide greater accuracy, as a given amount of error in a longer slope or line results in a smaller angular error. Accordingly, some levels are available in lengths up to six feet, for more precise work.

Clearly, a single six foot long level is relatively cumbersome to store, in comparison to shorter level lengths. In addition, a single, unitary level is relatively limited in its function, being usable only for defining a level line or perhaps a vertical line or slope, depending upon the adjustability or orientation of the level vial(s) therein. Most such devices include one or more linear measurement scales thereon, which provides some additional utility, but the versatility of the conventional level ends with these functions and features.

Other measuring and alignment tools are also required by the craftsman, e.g., framing squares and similar tools for laying out right angle corners and the like. Such tools are relatively bulky, due to the two legs of the instrument which are deployed at a right angle to one another. Framing squares and the like are also relatively limited in their function, generally providing only a right angle with different linear measurement scales along each leg of the square. As a result, the carpenter or other craftsman must provide a significant amount of storage space for the various conventional measurement tools required for accurate work. Due to the limited functions available in each of the above noted tools or devices, the craftsman must also must carry a number of different tools to the worksite in order to be certain that he or she will have the proper measurement tool for each function needed.

Accordingly, a need will be seen for a modular level which combines several of the above functions into a single tool which breaks down for compact storage and further utility when a smaller tool is required. The present invention provides a response to the above need in a modular level comprising two separable levels of unequal lengths, which may be joined linearly to form a single longer level or which may alternatively be joined at right angles to one another to form a square, with each leg of the square including level means therein. The present modular level may be stored as a single length with the two units joined linearly, or may alternatively be stored in a smaller area by separating the two components for parallel storage in a shorter storage area.

A discussion of the related art of which the present inventor is aware, and its differences and distinctions in comparison to the present invention, is provided below.

U.S. Pat. No. 233,203 issued on Oct. 12, 1880 to Henry T. Cushman, titled “Combined Ruler And Pencil Case,” describes a short (nine inch) ruler having two longitudinal components joined by a sliding dovetail joint. A compartment is provided within the two components, with the compartment extending nearly the entire length of the assembled components. While the present modular level may also include a storage compartment therein, the Cushman device teaches away from the present invention due to Cushman's essentially full length compartment which precludes provision of any level windows through the device. Also, Cushman does not provide any means of breaking down his ruler into shorter lengths.

U.S. Pat. No. 1,552,371 issued on Sep. 1, 1925 to George J. Williams, titled “Combination Knockdown Tool,” describes a level having three equal length sections which may be joined linearly to form a longer level length, or which may be joined at right angles to form a square, as desired. However, Williams fails to provide any closable storage compartment means within his device, even though he provides a separate plumb bob for which convenient storage would be an asset. The means used by Williams for the assembly of his level sections is also different from that used for the present invention, with Williams using a modified dovetail (T-slot) arrangement with threaded fasteners for tightly pulling up the attachment joints. The present measuring tool utilizes magnetic means for securing the different sections together, which provides considerably greater convenience and facilitates rapid assembly, disassembly, and reconfiguration of the device as desired.

U.S. Pat. No. 1,605,604 issued on Nov. 2, 1926 to Alric H. Nerbon, titled “Convertible Plumb And Level,” describes a level which may be separated into a series of shorter equal length segments, in the manner of the Williams device discussed immediately above. However, the Nerbon level is even more limited, as it cannot be used to form a square of any kind, as can the present invention. Nerbon also fails to disclose any form of storage compartment, and uses relatively cumbersome threaded attachments for securing the sections together, rather than the magnetic means used in the present modular level invention.

U.S. Pat. No. 1,670,432 issued on May 22, 1928 to Earle C. Baldon, titled “Joint For Combination Levels And Squares,” describes a tool having a series of equal length components each having an angularly adjustable joint therebetween. Each joint comprises a swivel link, which enables the two adjacent sections to be aligned or folded relative to one another. As in the cases of the other modular devices discussed further above, Baldon uses a threaded locking device to secure his level sections in the desired alignment. The sections of the Baldon tool can be locked to form right angles with one another, but Baldon fails to provide any form of linear measurement means or storage compartment with his tool, both of which are provided in the present modular level.

U.S. Pat. No. 4,653,194 issued on Mar. 31, 1987 to Yoon H. Kim, titled “Composite-Type Ruler,” describes a non-modular square and level assembly, in which one leg of the device includes slots or guides on opposite faces for the placement of an extended steel tape rule therein. The two slots include magnetic means for holding the steel tapes in place relative to the Kim tool. The Kim device is not modular, and cannot be separated into two or more components for reassembly in a straight line or as a square, as can the present modular level. As the Kim device is not modular, the magnetic means provided by Kim are not in the same relative locations in his device in comparison to the location of the magnets of the present modular level, nor do the Kim magnets provide the same function as those of the present modular level. Also, Kim does not provide any storage means with his device.

U.S. Pat. No. 4,700,489 issued on Oct. 20, 1987 to Anthony J. Vasile, titled “Square Level Measuring Tool,” describes a square with one leg including a set of level vials therein. This leg of the Vasile device also includes a retractable steel tape therein, and an exposed holder (not a closed compartment) for a single pencil or the like. The inability of the Vasile square to be reconfigured into separate components which may be assembled to form a single straight level or straightedge, results in a tool more closely related to the Kim device discussed immediately above, than to the present modular level invention.

U.S. Pat. No. 5,103,574 issued on Apr. 14, 1992 to Karen K. Levy, titled “Measuring Tool For Hanging Up Pictures And The Like,” describes a container having extendible linear scales therefrom. The scales may be extended to measure spacing for applying nails, screws, etc. to a wall for hanging a picture or the like. The container includes a pair of orthogonally disposed levels thereon. However, the Levy device is not modular, and cannot be broken down into separate components which can be reconfigured as a longer linear level or as a square, as provided by the present modular level invention. Moreover, as Levy does not provide for separation of the tool into various components, she does not include any means (magnetic or otherwise) for securing multiple components together, as provided by the present modular level invention.

U.S. Pat. No. 5,353,509 issued on Oct. 11, 1994 to Daniel C. Black, titled “Multi-Purpose T-Square And Level Combination Tool, ” describes a modular tool including two separable components, with one having a length about twice that of the other component. The two components each include a set of level vials therein, and means for joining the two sections. However, the joint means used by Black comprises threaded fittings, rather than the magnetic fittings used in the present modular level tool. Moreover, the Black level components can only form a T square, in which the shorter length component is secured symmetrically across one end of the longer component, rather than the more adaptable configuration of the present modular level in which one section can be extended at right angles to one end of the other section in either direction therefrom, to form two different framing square configurations. Also, Black does not provide a pencil compartment.

U.S. Pat. No. 5,433,011 issued on Jul. 18, 1995 to Dane Scarborough et al., titled “Combination Interlocking Segmented Level, ” describes a modular level including a plurality of sections which may have similar or different lengths. Each section has at least one level vial therein. However, the various sections interlock with one another by means of mating tongue and groove fittings, with a threaded fastener provided at each joint to lock the tongue and groove fittings together. Scarborough et al. do not provide any means for forming a square using their components, nor do they provide any storage compartment means, both of which features are a part of the present modular level.

U.S. Pat. No. 5,535,523 issued on Jul. 16, 1996 to Matthew K. Endris, titled “Carpenter's Square,” describes a modular square in which one leg has a pair of extensions and the second leg includes a transverse passage through one end for installing the extension of the first leg. The Endris tool is thus capable of forming only a square, with no means provided for assembling the two components in a straight line, end to end, as provided by the present modular level. Moreover, while Endris includes magnetic means in his tool, the magnet is in a different location relative to the connecting means and is not used to hold the two components together, as is the magnetic means of the present modular level. Endris also fails to provide any form of storage compartment in his carpenter's square tool.

U.S. Pat. No. 5,675,901 issued on Oct. 14, 1997 to James D. Young, titled “Segmented, Combination Level And Square Having A Rotating Joint, ” describes a modular tool in which the various segments are separable from one another and which may be assembled to form a straight rule, framing square, or other configuration as desired. At least one level means is provided along at least one of the segments or components. However, the Young tool segments secure together by means of frictional attachments, rather than the magnetic pin and socket arrangement used in the assembly of the present modular level components. Moreover, Young does not provide any form of pencil or other storage compartment in his device, whereas the present modular level includes a closable storage compartment for pencils and other accessories.

U.S. Pat. No. 5,819,427 issued on Oct. 13, 1998 to Barry L. Rohweder, titled “Carpenter's Pull-Apart Framing Square,” describes a modular tool using over center latches to secure the components together. Rohweder emphasizes the relative thinness of his tool assembly, which does not provide internal space for any form of storage compartment. Moreover, while Rohweder notes that one of the mating joint components may be provided medially along one of the sections, thereby allowing the device to be assembled as a T square, he refers to his device throughout the disclosure as a “square,” and does not describe any means of assembling the section end to end to form a straightedge, as provided by the present modular level. Also, while Rohweder discloses a magnet, the magnet is in one face of one of the sections, and only serves to secure the separated sections parallel to one another for storage, rather than holding them in their assembled state.

U.S. Pat. No. 6,041,510 issued on Mar. 28, 2000 to Charles A. Huff, titled “Extension Level, Square And Length Gauge,” describes a device comprising a series of linear sections which may be assembled to form a framing square. One of the sections also telescopes to form an elongate straightedge. At least one of the sections also includes a set of level vials therein. However, the Huff assembly uses threaded fasteners to lock the components together, rather than the magnetic attachment means of the present modular level. In addition, the sections of the Huff device are in the form of I beams having relatively thin central webs, with no room for any form of storage compartment therein.

U.S. Pat. No. 6,173,502 issued on Jan. 16, 2001 to Dane Scarborough, titled “Magnetically Engagable Level Sensing Apparatus And Standoff,” describes a level having a pair of opposed magnetic standoffs providing removable attachment to a ferrous metal pipe or the like. The device is not modular, and as it has no separable components, the magnets cannot be used to secure such components together, as in the case of the present invention. No square configuration can be formed by the '502 Scarborough device, nor does Scarborough provide any pencil or other storage compartment within the device, as provided in the present modular level invention.

U.S. Pat. No. D-332,755 issued on Jan. 26, 1993 to Frederick L. Beckner, titled “Combination Tool,” illustrates a design for a semi-folding level having a hinge or pivot between two straight portions. The hinge allows the two sections to be extended straight, or to be folded to an angle of ninety degrees relative to one another. The Beckner design is not modular, in the sense that the sections apparently cannot be separated from one another, as can the sections of the present modular level. Accordingly, Beckner does not appear to provide any magnetic means for attaching or holding the two sections together, as provided in the present modular level invention. Moreover, Beckner does not disclose any form of pencil or other storage compartment in his combination tool.

U.S. Pat. No. D-432,928 issued on Oct. 31, 2000 to Floyd H. Garrett, titled “Combined Ruler, Level And Adjustable Angle Square,” illustrates a design having three straight sections connected by a pair of pivots. The joints allow the various segments to be extended straight or to be folded to any angle desired, somewhat in the manner of a folding yardstick or the like. The levels of the Garrett design are apparently set in the circular pivots at each joint. No magnetic means or storage compartment is shown in the Garrett design, as provided in the present modular level invention.

British Pat. Publication No. 706,308 published on Mar. 24, 1954 to Fritz Reiterer, titled “A Combined Level And Try-Square,” describes a modular device in which one component has a pair of pins extending therefrom, with the other component having two mutually orthogonal mating sets of holes therein. The first component may thus be plugged into the second component to form either a straightedge or to form a framing square, with the arm of the square extending to either side of the opposite leg, as desired. Each section includes at least one level vial therein, but no container for pencils or other objects is disclosed in the '308 British Pat. Publication. While a metal plate is disclosed for the pin passages in one end of one of the sections, no magnetic means is provided for positively securing the two components together, as provided in the present modular level.

Finally, World Pat. Publication No. 94/02799 published on Feb. 3, 1994 to Betts & Sons Ltd., titled “Tape Measure And Accessory Combinations,” describes a retractable steel measuring tape incorporating various features, including an elongate tube for frictionally holding a pencil or the like therein and a bubble level disposed in the side of the case. The relatively short and squat case cannot be divided to form elongate linear modules, as in the case of the present modular level invention, and thus there is no motivation to provide any magnetic attachment means for the device, as provided in the mating ends of the components of the present modular level.

None of the above inventions and patents, taken either singly or in combination, is seen to describe the instant invention as claimed.

### SUMMARY OF THE INVENTION

The present invention comprises a modular level, having two different sections or components of unequal length. Each component includes a plurality of spirit level vials therein, for measuring level or vertical lines in various orientations. One component includes a pair of pins extending therefrom, while the opposite component includes mating pairs of passages at each end thereof. One of the mating pairs of passages is aligned so the two level components may be joined end to end to form a straight length, while the opposite pair of passages is orthogonal to the first set so the two components form a framing square when assembled.

The mating pins and sockets or passages of the two components include magnetic means for positively securing the components together. The magnetic means may comprise mutually attractive ferrometallic magnetic plates in the adjacent surfaces of the components when they are assembled, ferrometallic or magnetically pins which mate with mutually attractive ferrometallic or magnetically attractive sleeves in the mating component, or magnetically attractive “keepers” extending across the internal ends of the ferrometallic pins and mating sleeves. A closable compartment may be provided for the positive retention and carriage of one or more pencils or other comparably sized objects therein.

Accordingly, it is a principal object of the invention to provide a modular level having separable first and second components of unequal length for selectively joining together to form a single elongate straightedge or framing square, as desired.

It is another object of the invention to provide a modular level including a plurality of spirit level vials in each of the components, for determining level and vertical lines as desired.

It is a further object of the invention to provide a modular level having a first component which includes a pair of pins extending therefrom and parallel to the major axis thereof, and a second component which includes a first pair of mating passages parallel to the major axis thereof in a first end thereof and a second pair of mating passages normal to the major axis thereof in a second end thereof, for assembling the two components aligned with one another or perpendicular to one another as desired.

Still another object of the invention is to provide a modular level including standard stud spacing indicator means, cooperating level indicator means, and storage compartment means therewith.

It is an object of the invention to provide improved elements and arrangements thereof in an apparatus for the purposes described which is inexpensive, dependable and fully effective in accomplishing its intended purposes.

These and other objects of the present invention will become apparent upon review of the following specification and drawings.

### BRIEF DESCRIPTION OF THE DRAWINGS

FIG. 1 is an exploded perspective view of a first embodiment of the present modular level, showing the two level sections and their assembly means.

FIG. 2 is a detailed perspective view in partial section of the level component connecting means of the modular level assembly of FIG. 1.

FIG. 3 is an exploded perspective view of an alternate embodiment of the assembly of FIG. 1, showing the assembly of the components to form a right angle corner level or framing square.

FIG. 4 is an exploded perspective view showing a detail of the connecting means for the level components of FIG. 3.

FIG. 5 is a broken away detail perspective view of the pencil compartment of the present modular level invention.

Similar reference characters denote corresponding features consistently throughout the attached drawings.

### DETAILED DESCRIPTION OF THE PREFERRED EMBODIMENTS

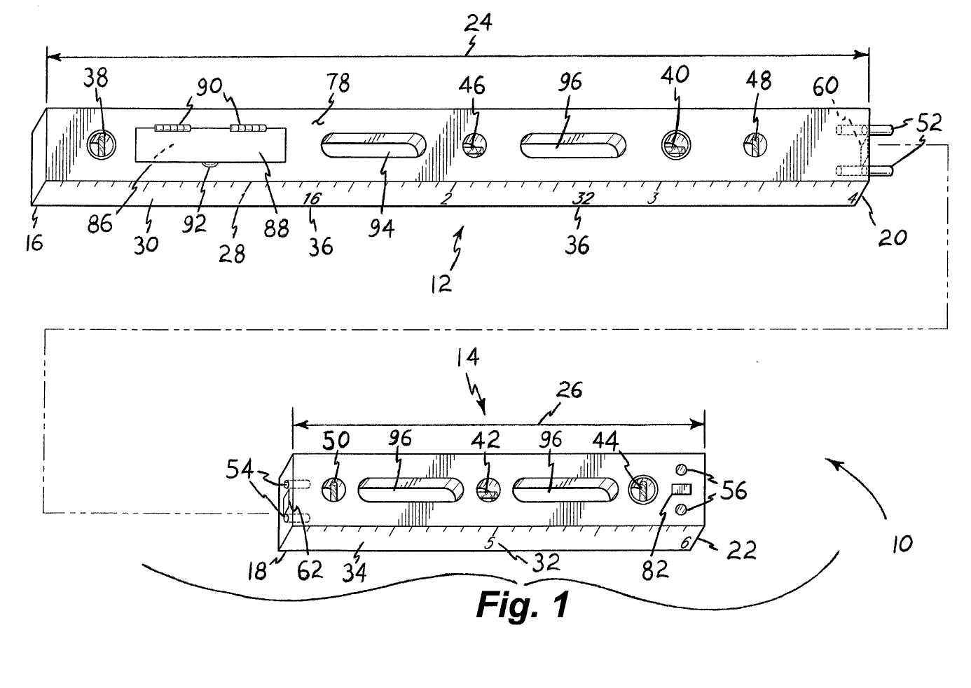

The present invention is a modular level, comprising various embodiments of connectable first and second level components which may be joined end to end to form a single elongate level, or which may be joined orthogonally to one another to form a framing square or the like. FIG. 1 provides a perspective view of a first embodiment of the present modular level assembly 10, comprising a first elongate level component 12 and a second elongate level component 14. Each of the levels 12 and 14 has a first end, respectively 16 and 18, and an opposite second end, respectively 20 and 22, with the respective opposite ends of the first and second levels 12 and 14 defining respective first and second level component lengths 24 and 26 therebetween.

The first level component 12 preferably has a length 24 considerably longer than the length 26 of the second level component 14, although the level component lengths 24 and 26 may be adjusted as desired. The level 12 of FIG. 1 has a length 24 of four feet, with the foot marks designated by the indicators “1” through “4” along the linear scale 28 provided along the first edge 30 of the first level component 12. It will be seen that the linear scale 28 may have its origin point at either end of the first level component 12, as desired. However, a second linear scale 32 is preferably provided along the first edge 34 of the second level component 14, with the two linear scales 28 and 32 forming a continuously progressive linear scale when the two level components 12 and 14 are joined end to end.

The linear scale 28 of the first level component 12 may also provide additional stud spacing indicators 36 at each sixteen inch increment therealong. Conventionally, vertically disposed wall studs are spaced sixteen inches apart in construction. The present modular level invention enables the carpenter or other worker to align wall studs relative to the vertical by means of the level vials provided therewith, and also allows the worker to space the studs accurately by means of the stud spacing indicators 36, using the same tool for both operations. While additional stud spacing indicators are not provided on the second level component 14, it will be seen that they may be provided thereon if so desired, to provide a continuously progressive stud spacing scale extending for the full additive length of the assembled level components 12 and 14.

Each of the level components 12 and 14 includes at least one level indicating means (spirit level vial, etc.) therein, and preferably includes at least two such level vials, respectively 38 and 40 for the first level component 12 and 42, 44 for the second level component 14, with the respective level vial pairs 38, 40 and 42, 44 being disposed orthogonally relative to one another This allows either of the level components 12 and/or 14 to be used to determine a level line, or to check the accuracy of a vertical line as defined by a wall stud or the like. Additional level vials 46, 48, 50, etc. may be provided in either or both level components 12 and/or 14, as desired.

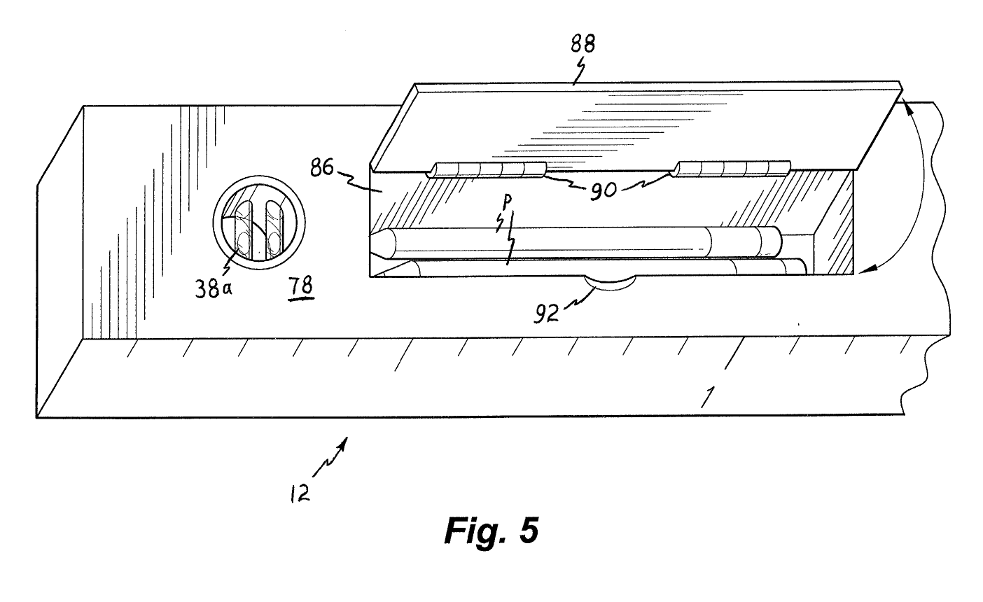

Certain vials, e.g., vials 38, 40, and 44, are marked with an additional identifier ring to indicate their locations respectively near the first end, center, and second end of the level assembly when the two level components 12 and 14 are assembled end to end. Such markings (or others) may be helpful to the user of the present modular level in assembling the two level components 12 and 14 in the desired configuration, discussed further below. It should be noted that while only a single spirit level vial 38 through 50 is shown in each level window of the two level components 12 and 14, plural level vials may be provided in one or more windows to provide for the inversion of the components 12 and 14 or assembly, as illustrated in FIG. 5 of the drawings. Also, while the drawings illustrate spirit or “bubble” level vials, it should be noted that other conventional level indicator means (electronic, etc.) may be used in lieu of or in combination with the illustrated spirit level vials, as desired.

The two level components 12 and 14 may be assembled to form a single, straight level assembly or at right angles to one another to form a framing square or the like, as noted further above. Each of the level components 12 and 14 accordingly includes some form of magnetic attachment means for securing the components together, as desired. The first level component 12 has a first level magnetic attachment means comprising a pair of parallel magnetically attractive pins 52 extending from the second end 20, with the two pins 52 being parallel to the elongate axis or length 24 of the level component 12.

The second level component 14 has second level magnetic attachment means comprising a pair of parallel magnetically attractive sockets 54 parallel to its length 26 disposed in its first end 18, and third level magnetic attachment means comprising another pair of magnetically attractive sockets 56 disposed orthogonally to its length 26 disposed in its second end 22. The two socket pairs 54 and 56 have internal diameters and spacing substantially equal to the diameters and spacing of the first attachment means pins 52, to provide an accurate assembly of the two level components 12 and 14 with practically no play therebetween.

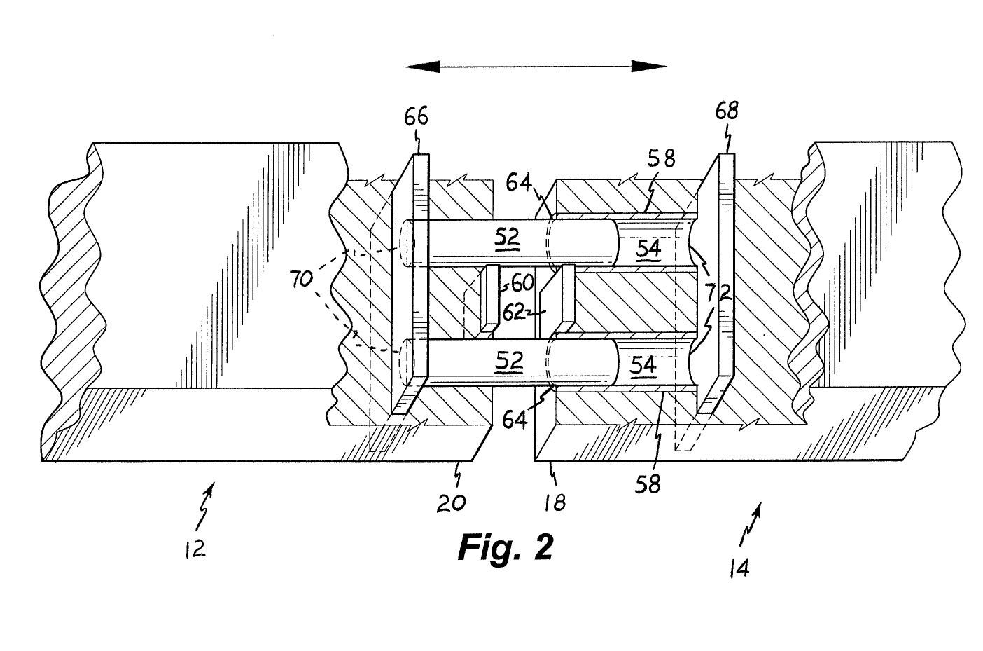

FIG. 2 of the drawings provides a detailed view of the assembly of the first attachment means (pins 52 of the first level component 12) with the second attachment means (sockets 54 of the second level component 14). Each of the sockets 54 preferably includes a magnetically attractive sleeve 58 therearound. These sleeves 58 may comprise some form of ferrous metal which is magnetically attracted to the magnetic pins 52, or may comprise magnets to attract pins 52 formed of ferrous metal. The specific magnetic relationship is not critical, so long as some form of magnetism is used to provide the mutually attractive force between the two fittings 52 and 54, or 52 and 56. In addition, a pair of magnetically attractive plates 60 and 62 (magnet and ferrous metal, etc.) may be placed respectively between the pins 52 of the first level component 12 and between the open ends 64 of the sockets 54 of the second component 14, for further attachment security.

In addition to the above discussed magnetic and/or ferrous metal pins 52, socket sleeves 54, and plates 60 and 62, magnetic keepers, respectively 66 and 68, may be provided internally at the internal ends 70 of the two magnetically attractive pins 52 and at the internal ends 72 of the two magnetically attractive sleeves 58 of the two sockets 54. The “keeper” bars disposed across the ends of the pairs of magnetic pins 52 and sockets 54, concentrates the magnetic flux and serves to increase the strength of the magnetic attraction of the magnets. The keeper bars 66 and 68 may comprise bars of ferrous metal, or may be formed of magnets, as desired. The net effect is to provide an even stronger magnetic attraction between the two pins 52 and mating sockets 54, to assure positive assembly of the two level components 12 and 14 as desired.

As the pins 52 and sockets 54 are both aligned parallel to the major axes or lengths 24 and 26 of their respective levels 12 and 14, the installation of the pins 52 into the sockets 54 results in the two components 12 and 14 forming a single, straight, elongate level assembly, with their respective lengths 24 and 26 additively combining to form essentially a single level having an overall length equal to the individual lengths of the two level components 12 and 14. However, the third magnetically attractive means of the two sockets 56 disposed in the second end 22 of the second level 14 are at right angles to the second magnetically attractive sockets 54 of the first end 18 of the second level 14, with the assembly of the two level components 12 and 14 forming a right angle when joined using the second end sockets 56 of the second level 14.

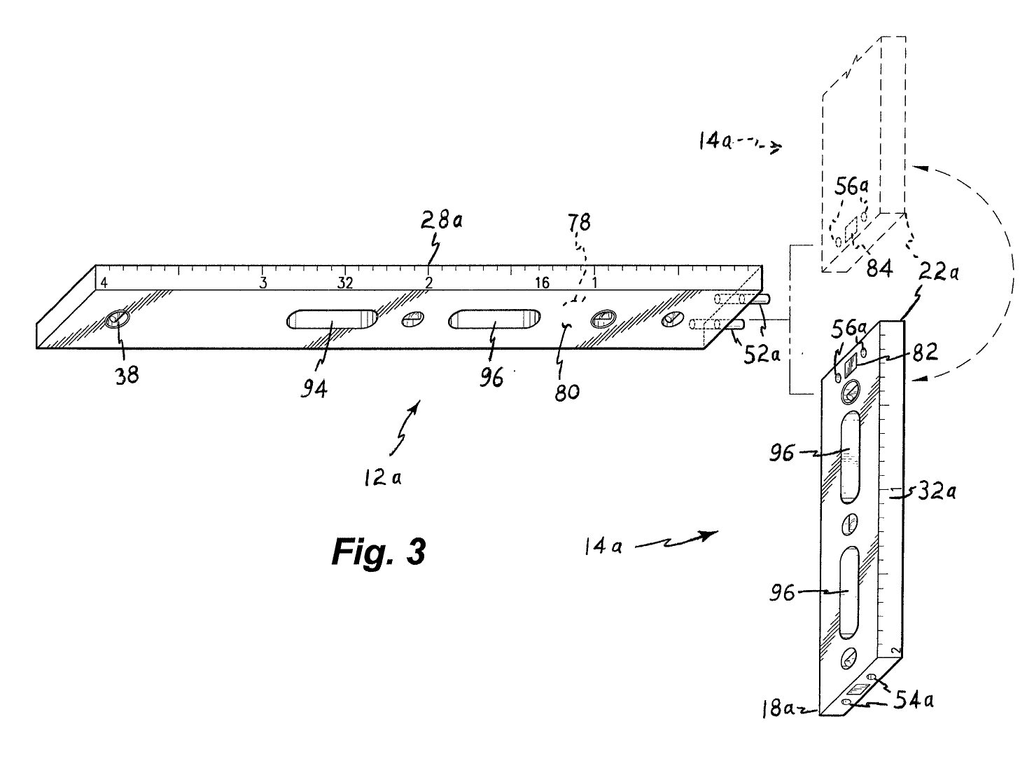

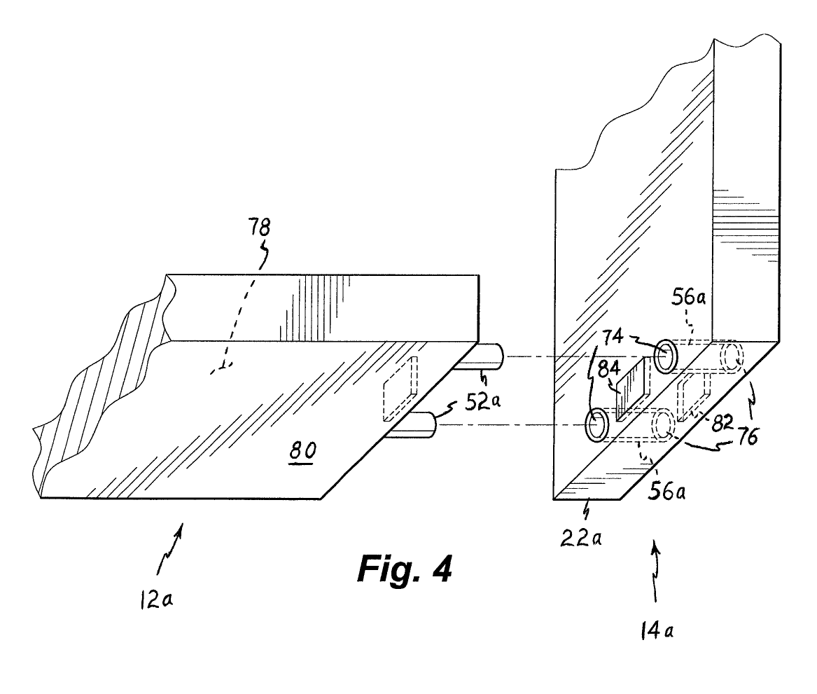

FIGS. 3 and 4 of the drawings illustrate the above assembly, with the two level components 12a and 14a being essentially identical to the components 12 and 14 of FIGS. 1 and 2, with the exception of their respective linear scales 28a and 32a, which run in the opposite directions from the scales 28 and 32 of the first and second level components 12 and 14 of FIGS. 1 and 2. It will be seen that the orientation of the scales 28, 32, 28a, and/or 32a may be arranged in any direction desired, to provide convenient linear measurement from either end of the components or assembly as desired. While the drawings only show a single linear scale disposed along one edge of each component in each view, it will be understood that each edge may have such a linear scale thereon, with the scales having either the same orientation and origin points or different orientation and origin points, as desired.

In FIGS. 3 and 4, the third magnetically attractive means comprising the two magnetically attractive sockets or passages 56a of the second end 22a of the second level 14a are disposed through the second level 14a and orthogonal to its length, rather than parallel thereto as in the magnetically attractive sockets 54a of the first end 18a of the second level component 14a. This is the same arrangement disclosed in FIGS. 1 and 2 for the magnetically attractive sockets 56 of the second level component 14. These two sockets 56a (and the sockets 56 of the component 14 of FIGS. 1 and 2) pass completely through the second level component, thus enabling the second level component 14a (or 14) to be reversed orthogonally relative to the first component 12 (or 12a ).

FIGS. 3 and 4 provide a clear illustration of this assembly. The opposed first and second open end pairs, respectively 74 and 76 illustrated in FIG. 4 for the sockets 56a, allow the second level component 14a to be secured to the pins 52a of the first level component 12a from either direction, i.e., forming a ninety degree, right angle between the second level 14a and the second face 80 of the first level 12a, as shown in solid lines in FIG. 3, or alternatively turning the second level component 14a end for end and forming a ninety degree right angle between the second level component 14a and the first face 78 of the first level component 12a, as shown by the second level component 14a in broken lines in FIG. 3 and by the broken away second end 22a shown in solid lines in FIG. 4. This orthogonal assembly of the two level components 12a and 14a (or 12 and 14 of FIGS. 1 and 2) provides a notable advance in versatility for the present invention, by allowing the levels to be used as a framing square, if so desired.

It was noted further above that the open outer ends 64 of the two sockets 54 of the second level 14 may include a magnetically attractive plate 62 therebetween. In the same manner, the opposed open or outer end pairs 74 and 76 of the second sockets 56a of the second component 14a may include opposed third and fourth magnetic plates, respectively 82 and 84, therebetween, to provide a stronger magnetic attachment for the two levels 12a and 14a when assembled as a square. Identical plates 82 and 84 may be provided between the open end pairs of the second sockets 56 of the second component 14 of FIGS. 1 and 2 for the same purpose, if so desired.

Further versatility for the present modular level invention is provided by a selectively closable storage compartment 86 formed in the body of the first level component 12 (or 12a ), a detail of which is illustrated in FIG. 5 of the drawings. A closable lid 88 provides access to the compartment 86 through the first face 78 of the first level component 12 (or 12a), as illustrated in FIGS. 1 and 5 of the drawings. The lid 88 may be secured by spring hinges 90 which urge the lid 88 to a closed position, with a finger depression 92 providing opening access, or other means (e.g., a sliding or folding lid, retaining clip at lid edge, etc.) may be provided to close the compartment 86 as desired.

The storage compartment 86 is preferably relatively long, fitting between the first level indicator means 38 (or 38a in FIG. 5, with its two opposed level vials for inverting the level 12 end to end, as required) and the first hand hold 94, in order to retain elongate articles (e.g., carpenter's framing pencils P, chalk, etc.) therein. It will be seen that such a storage compartment(s) may also be provided at other locations along the first level component 12 (or 12a), and/or in the second level component 14 (or 14a), if so desired, by suitably arranging other structure, e.g., spirit or other level indicator means and hand holds 96, etc.

In conclusion, the present modular level provides a significant advantage over earlier levels of the prior art. The versatility of the present tool, with its two separate levels each having a different length, means for combining the two levels as a single elongate level providing an even longer additive length or alternatively forming a framing square, and the storage compartment provided in at least one of the level components, provide a broad range of tools or measuring devices heretofore only available as a series of separate tools or devices. The present tool can serve as a level having any one of three different lengths, a framing square having two different orientations, a linear measuring device having several different scales, a stud spacing gauge, and in addition, includes a storage compartment suitable for holding pencils or other marking implements, or other articles of appropriate size. Thus, the present modular level will prove to be a most valuable addition to the toolbox of the carpenter or other worker who has need of the various tools and devices provided by the present modular level and its associated features.

It is to be understood that the present invention is not limited to the embodiments described above, but encompasses any and all embodiments within the scope of the following claims.

I claim:

1. A modular level, comprising:
an elongate first level component having a first end, a second end opposite said first end, and a first level component length defined therebetween;
an elongate second level component having a first end, a second end opposite said first end, and a second level component length defined therebetween;
each said level component including at least one level indicator therein;
first magnetic attachment means disposed at said second end of said first level component for attaching said first level component to said second level component;
second magnetic attachment means disposed in said second level component, for magnetically connecting each said level component and forming a single, straight, elongate level assembly additively comprising said first level component length and said second level component length; and
third magnetic attachment means disposed in said second level component, for magnetically connecting each said level component orthogonally to one another and forming a framing square.

2. The modular level according to claim 1, wherein:
said first magnetic attachment means comprises a pair of magnetically attractive pins;
said second magnetic attachment means comprises a pair of magnetically attractive sockets disposed within said first end of said second level component and parallel to said second level component length thereof, for selectively mating with said magnetically attractive pins; and
said third magnetic attachment means comprises a pair of magnetically attractive sockets disposed within said second end of said second level component and normal to said second level component length thereof, for selectively mating with said magnetically attractive pins.

3. The modular level according to claim 2, further including:
a first magnetically attractive plate disposed between said magnetically attractive pins of said first level component;
an open end defined by each of said magnetically attractive sockets of said second magnetic attachment means;
a second magnetically attractive plate disposed between each said open end of said magnetically attractive sockets of said second magnetic attachment means;
opposed first and second open ends defined by each of said magnetically attractive sockets of said third magnetic attachment means; and
a third and a fourth magnetically attractive plate disposed respectively between each said first and said second open ends of said magnetically attractive sockets of said third magnetic attachment means.

4. The modular level according to claim 2, further including:
internal ends disposed within said first level component for said magnetically attractive pins and within said second level component for said pair of magnetically attractive sockets of said second magnetic attachment means; and
magnetic keeper means disposed across said internal ends of said magnetically attractive pins and said pair of magnetically attractive sockets of said second magnetic attachment means.

5. The modular level according to claim 2, wherein:
said first level component has a first face and a second face opposite said first face; and
said magnetically attractive sockets of said third attachment means pass completely through said second end of said second level component, for selectively attaching said second end of said second level component orthogonally to said second end of said first level component and forming a right angle between either of said first face and said second face of said first level component and said second level component, as desired.

6. The modular level according to claim 1, further including a selectively closable storage compartment disposed within said first level component.

7. The modular level according to claim 1, wherein said at least one level indicator of said first level component and said second level component each comprise at least two mutually orthogonal level vials disposed within each of said first level component and said second level component.

8. A modular level, comprising:
an elongate first level component having a first end, a second end opposite said first end, and a first level component length defined therebetween;
an elongate second level component having a first end, a second end opposite said first end, and a second level component length defined therebetween;
each said level component including at least one level indicator therein; and
a selectively closable storage compartment disposed within said first level component.

9. The modular level according to claim 8, further including:
first magnetic attachment means disposed at said second end of said first level component for attaching said first level component to said second level component;
second magnetic attachment means disposed in said second level component, for magnetically connecting each said level component and forming a single, straight, elongate level assembly additively comprising said first level component length and said second level component length; and
third magnetic attachment means disposed in said second level component, for magnetically connecting each said level component orthogonally to one another and forming a framing square.

10. The modular level according to claim 9, wherein:
said first magnetic attachment means comprises a pair of magnetically attractive pins;
said second magnetic attachment means comprises a pair of magnetically attractive sockets disposed within said first end of said second level component and parallel to said second level component length thereof, for selectively mating with said magnetically attractive pins; and
said third magnetic attachment means comprises a pair of magnetically attractive sockets disposed within said second end of said second level component and normal to said second level component length thereof, for selectively mating with said magnetically attractive pins.

11. The modular level according to claim 10, further including:
a first magnetically attractive plate disposed between said magnetically attractive pins of said first level component;
an open end defined by each of said magnetically attractive sockets of said second magnetic attachment means;
a second magnetically attractive plate disposed between each said open end of said magnetically attractive sockets of said second magnetic attachment means;
opposed first and second open ends defined by each of said magnetically attractive sockets of said third magnetic attachment means; and
a third and a fourth magnetically attractive plate disposed respectively between each said first and said second open ends of said magnetically attractive sockets of said third magnetic attachment means.

12. The modular level according to claim 10, further including:
internal ends disposed within said first level component for said magnetically attractive pins and within said second level component for said pair of magnetically attractive sockets of said second magnetic attachment means; and
magnetic keeper means disposed across said internal ends of said magnetically attractive pins and said pair of magnetically attractive sockets of said second magnetic attachment means.

13. The modular level according to claim 10, wherein:
said first level component has a first face and a second face opposite said first face; and
said magnetically attractive sockets of said third attachment means pass completely through said second end of said second level component, for selectively attaching said second end of said second level component orthogonally to said second end of said first level component and forming a right angle between either of said first face and said second face of said first level component and said second level component, as desired.

14. The modular level according to claim 8, wherein said at least one level indicator of said first level component and said second level component each comprise at least two mutually orthogonal level vials disposed within each of said first level component and said second level component.

15. A level, comprising:
at least one elongate level component having a first end and a second end opposite said first end, with a level component fixed length defined therebetween;
at least two mutually orthogonal level vials disposed within said at least one level component; and
a selectively closable storage compartment disposed within said at least one level component.

16. The level according to claim 15, wherein said at least one level component comprises a first level component and a second level component, the level further comprising:
first magnetic attachment means disposed at said second end of said first level component for attaching said first level component to said second level component;
second magnetic attachment means disposed in said second level component, for magnetically connecting each said level component and forming a single, straight, elongate level assembly additively comprising said first level component length and said second level component length; and
third magnetic attachment means disposed in said second level component, for magnetically connecting each said level component orthogonally to one another and forming a framing square.

17. The level according to claim 16, wherein:
said first magnetic attachment means comprises a pair of magnetically attractive pins;
said second magnetic attachment means comprises a pair of magnetically attractive sockets disposed within said first end of said second level component and parallel to said second level component length thereof, for selectively mating with said magnetically attractive pins; and
said third magnetic attachment means comprises a pair of magnetically attractive sockets disposed within said second end of said second level component and normal to said second level component length thereof, for selectively mating with said magnetically attractive pins.

18. The level according to claim 16, further including:
a first magnetically attractive plate disposed between said magnetically attractive pins of said first level component;
an open end defined by each of said magnetically attractive sockets of said second magnetic attachment means;
a second magnetically attractive plate disposed between each said open end of said magnetically attractive sockets of said second magnetic attachment means;
opposed first and second open ends defined by each of said magnetically attractive sockets of said third magnetic attachment means; and
a third and a fourth magnetically attractive plate disposed respectively between each said first and said second open ends of said magnetically attractive sockets of said third magnetic attachment means.

19. The level according to claim 16, further including:
internal ends disposed within said first level component for said magnetically attractive pins and within said second level component for said pair of magnetically attractive sockets of said second magnetic attachment means; and
magnetic keeper means disposed across said internal ends of said magnetically attractive pins and said pair of magnetically attractive sockets of said second magnetic attachment means.

20. The level according to claim 16, wherein:
said first level component has a first face and a second face opposite said first face; and
said magnetically attractive sockets of said third attachment means pass completely through said second end of said second level component, for selectively attaching said second end of said second level component orthogonally to said second end of said first level component and forming a right angle between either of said first face and said second face of said first level component and said second level component, as desired.
